(19) United States
(12) Patent Application Publication
(10) Pub. No.: US 2014/0156750 A1
(43) Pub. Date: Jun. 5, 2014

(54) Computer-Implemented System And Method For Verifying Online Dating Profiles

(71) Applicant: PALO ALTO RESEARCH CENTER INCORPORATED, Palo Alto, CA (US)

(72) Inventors: Emiliano De Cristofaro, Mountain View, CA (US); Victoria M. Bellotti, San Francisco, CA (US); Gregory Norcie, Bloomington, IN (US)

(73) Assignee: PALO ALTO RESEARCH CENTER INCORPORATED, Palo Alto, CA (US)

(21) Appl. No.: 13/706,251

(22) Filed: Dec. 5, 2012

(51) Int. Cl. H04L 29/08

(52) U.S. Cl. CPC H04L 67/02
USPC 709/204

(57) ABSTRACT

A system and method for verifying online dating profiles is provided. A profile is retrieved for a user on an online dating site. A social network page is identified for the user. Information about the user is accessed from the social network page, wherein the information includes one or more fields of metadata. The metadata from at least one of the fields on the social network page is compared with metadata from a corresponding field of the online dating site. A determination is made as to whether the metadata of the social network page matches the metadata of the online dating site. A certification status of the metadata is assigned to at least one of the fields on the online dating site. A certified status is assigned to the metadata when a match occurs. An uncertified status is assigned to the metadata when no match occurs.

### FIELD

This application relates in general to online dating, and in particular, to a system and method for verifying online dating profiles.

### BACKGROUND

Increasing numbers of people have turned to online dating services to meet a partner. Online dating allows users to connect and get to know one another online via a computer prior to a face-to-face meeting, and has become an acceptable method for finding a mate. According to the Pew Internet and American Life Project, 36% of people who classify themselves as single, report using online dating services.

Many online dating sites require a user to generate a profile page on which characteristics of the user are displayed. Desired characteristics of a potential partner can also be provided by the user and displayed. The user characteristics and desired partner characteristics can be used to automatically identify suitable matches for providing to the user. Additionally, the user can conduct a search by viewing profiles of other users, some of which the user may take an interest in contacting or getting to know better. The information provided on an online dating profile plays a large role in influencing the user's interest in the person associated with that profile.

However, the information may be false or not be entirely truthful, potentially misleading the user. Accordingly, users of online dating profiles might be weary of communicating with, meeting, or becoming emotionally involved with other users online.

For instance, eHarmony of Santa Monica, Calif. provides a structured online dating site, which requires users to generate a profile by filling out a lengthy questionnaire prior to viewing online dating profiles of other users. Subsequently, the completed profile is compared with other profiles and matches are identified based on 29 predetermined key points. The matches are provided in batches of seven profiles. If the user wishes to communicate with one of the matches, the communication is structured and must follow four predetermined stages. Each stage must be completed prior to moving to the next stage. A stage is determined to be complete after the user and the match ask and answer particular types of questions, which are determined by the stage. The first stage involves close-ended questions, the second stage involves sharing personal lists of likes and dislikes, the third stage involves open-ended questions and the last stage involves email correspondence. However, throughout the structured stages of communication, eHarmony fails to ensure that the information provided by the users is valid.

Thus, there is a need for a system and method to automatically verify online dating profiles to ensure the veracity of the information provided on the profile and to prevent misleading other users.

### SUMMARY

Single individuals can attempt to find a partner by participating in online dating, for example, without having to physically attend events. However, many users may be hesitant to participate in online dating services or share information about themselves with others via written communication due to security concerns. Certifying information provided by participants of online dating services can ease a user's concerns that the information provided is truthful. The information can be certified via an application that uses data from the participants' social networking profiles and notice of the certification can be displayed.

A further embodiment provides A system and method for verifying online dating profiles is provided. A profile is retrieved for a user on an online dating site. A social network page is identified for the user. Information about the user is accessed from the social network page, wherein the information includes one or more fields of metadata. The metadata from at least one of the fields on the social network page is compared with metadata from a corresponding field of the online dating site. A determination is made as to whether the metadata of the social network page matches the metadata of the online dating site. A certification status of the metadata is assigned to at least one of the fields on the online dating site. A certified status is assigned to the metadata when a match occurs. An uncertified status is assigned to the metadata when no match occurs.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for verifying online dating profiles, in accordance with one embodiment.

FIG. 2 is a flow diagram showing a method for verifying online dating profiles, in accordance with one embodiment.

FIG. 3 is a flow diagram showing, by way of example, a process for determining a certification status for an information field on an online dating profile.

FIG. 4 is a block diagram showing, by way of example, a screenshot of an introduction page for certifying online dating profiles.

FIG. 5 is a block diagram showing, by way of example, a screenshot of a selection page for selecting information fields to certify.

FIG. 6 is a block diagram showing, by way of example, a screenshot of a social network page.

FIG. 7 is a block diagram showing, by way of example, a screenshot of an online dating profile page with field certification.

### DETAILED DESCRIPTION

Online dating has become a popular method for single users to find partners. Online dating offers many benefits, including convenience, partial anonymity, such as until a face-to-face meeting, and less costly than in person dating. However, some users are hesitant to participate in online dating services or if they do, may be hesitant to share enough information to make online dating successful, due to security concerns. For instance, participants can provide false or inaccurate information, including relationship statuses, age, or fake profile pictures, as well as other false information, which can mislead the user who is providing true information about him or her self.

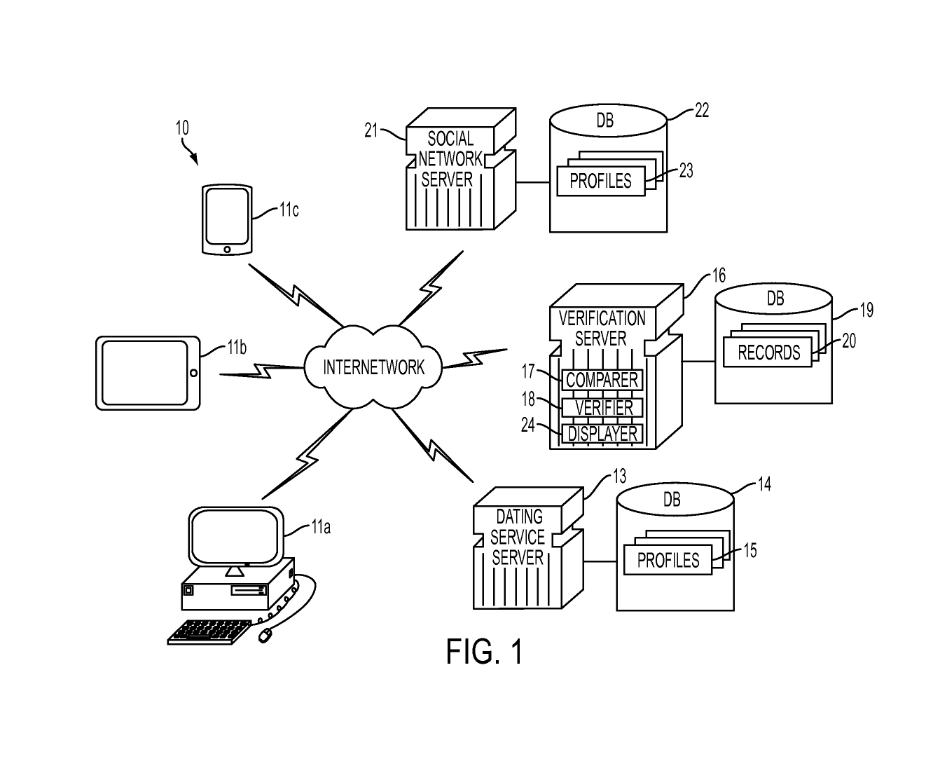

The information provided by participants of an online data service can be verified to relieve users' concerns with the information provided. FIG. 1 is a block diagram showing a system 10 for verifying online dating profiles, in accordance with one embodiment. A registered participant or user of an online dating service can access his online dating profile 15 on a computer 11a, tablet 11b, or mobile computing device 11c via a dating service server 13 associated with the online dating service. Specifically, the participant can request his profile, such as on a Website for the online dating service, which is transmitted via an internetwork, such as the Internet 12 to the dating service server 13. The dating service server obtains the identified profile 15, which is stored with other profiles for other participants on a database 14 that is interconnected to the dating service server 13. The online dating service can include, for example, Match.com, eHarmony, or Zoosk, as well as other online dating services. Hereinafter, the terms “participant” and “user” each refer to an individual registered with an online dating service are used interchangeably with the same intended meaning, unless otherwise indicated.

The requested profile 15 is transmitted to the participant and displayed on the computer 11a, tablet 11b, or mobile computing device 11c. The participant profile can include one or more fields of information about the participant, such as inter alia, age, status, hair color, eye color, occupation, salary, and hobby, that are displayed to other participants of the online dating service. The participant can choose to verify the information provided on his profile by accessing an application that certifies whether the online dating profile information is accurate based on information provided by the participant on a separate social networking site.

To certify the online dating profile information, a verification server 16 can access information about the participant from a social network server 21 via an application programming interface (API). The social network server 21 is interconnected to a database that stores social network profiles 23 with information about each user associated with a social networking service. The social networking service can include, for example, Facebook, MySpace, Twitter, or LinkedIn, as well as other social networking services. The information stored on the social network server 21 can include metadata for information fields, such as age, relationship status, hair color, eye color, occupation, salary, and hobbies, as well as other information. For example, for relationship status, the metadata fields can include single, married, divorced, or widowed.

The verification server 16 can be a trusted or non-trusted third party and includes a comparer 17, a verifier 18, and a displayer 24. The comparer reviews the social network information obtained from the social network server 21 and compares at least a portion of the social network information with the online dating information. The verifier 18 determines whether the social network information matches the online dating information provided by the participant based on the comparison. If the social network information and the online dating information match, the online data information is assigned a certification status. The displayer 24 provides notice of the certification on the participant's profile on the online dating site. If there is no match, the displayer 24 provides notice that the online dating information is not certified. Results of the comparison, including the certified and non-certified status can be stored as records 20 in a database 19 interconnected to the verification server 16.

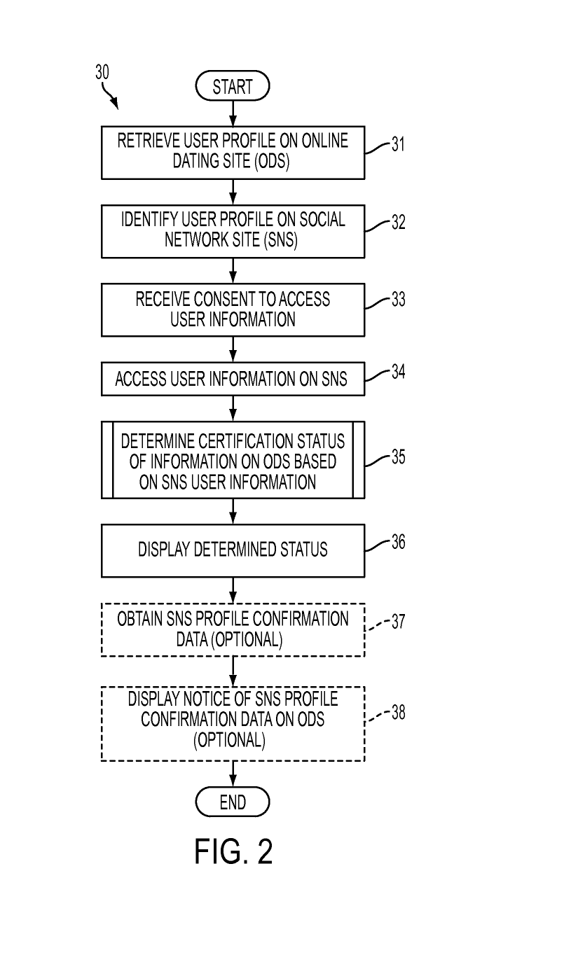

Certifying and displaying certification of participant information on an online dating profile can help ease concerns regarding security by distinguishing true information from false or misleading information. FIG. 2 is a flow diagram showing a process 30 for verifying online dating profiles, in accordance with one embodiment. A user profile is obtained for a participant of an online dating service (block 31). The profile is displayed and accessible by other participants via a Website for the online dating service. The profile can include fields of information about the participant, including, inter alia, age, relationship status, hair color, eye color, height, body type, sign, occupation, salary, children, smoker, drinker, exercise, religious beliefs, political views, charities, movies, pets, hangouts, hobbies, books, language, and education. Further, metadata provided by the participant for one or more of the information fields is stored and displayed on the profile. For instance, the occupation information field can include metadata fields for doctor, basketball player, student, lawyer, singer, or gardener, as well as many other occupations. Other information fields and metadata fields are possible. Additionally, the profile can also include desired traits for a potential partner, including one or more of the information fields used to describe the participant. Next, a profile for the participant on one or more social networking sites is identified (block 32). Information, including traits of the participant is accessed (block 34). The information can include fields that are the same as or different from the fields of information for the online dating profile, which are listed above. Prior to accessing the information, consent can be obtained (block 33) from the participant. The consent can be obtained separately for each information field, as a general consent for all the information fields, or by groupings of information.

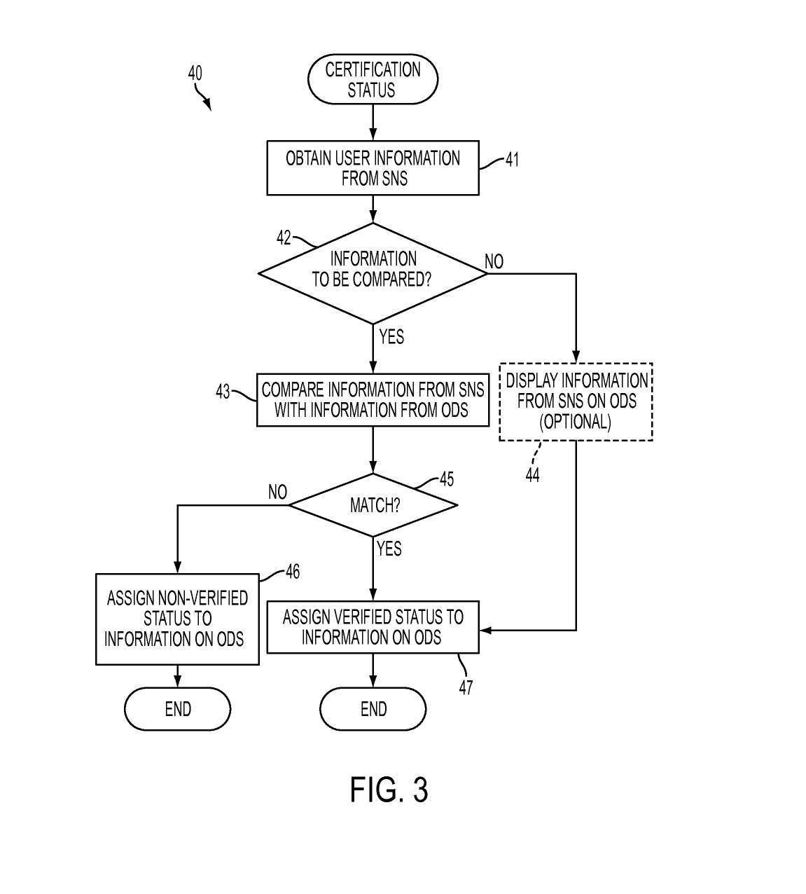

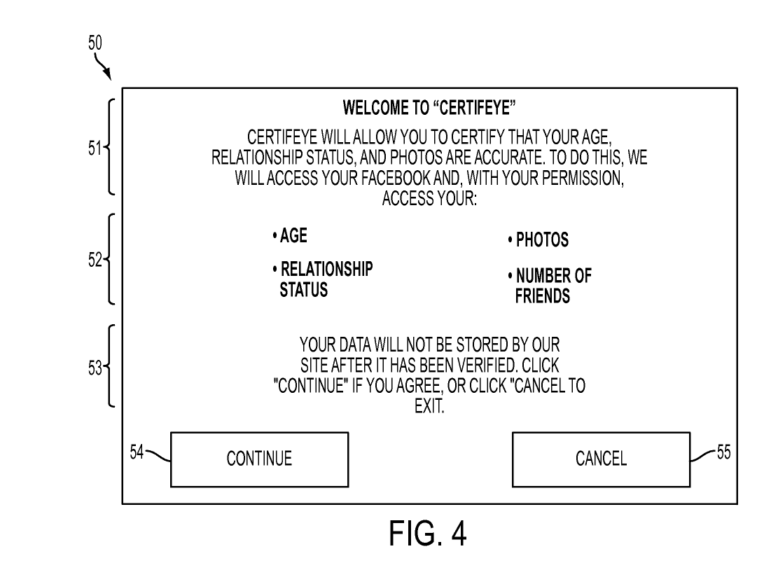

A certification status for each of the information fields on the participant's online dating profile is determined (block 35). The certification status can be determined by downloading data from the social network page to the online dating profile, or verifying the matching or the similarity of information on the social network page with the online dating profile. However, other methods for determining a certification status of information on the online dating profile are possible. Determining a certification status is further described below with reference to FIG. 3. Once the certification status for each field of information is determined, the status is displayed (block 36) with the corresponding information field on the participant's online dating profile to notify other participants of the dating service that the information has been reviewed and verified. The certification display can include different color badges based on the assigned status, a pop up window with the certification statuses, different types of font or different font size of the information fields, as well as other types of display. Displaying the certification status for each information field is further discussed below with reference to FIG. 4.

Since the certification status of the online dating profile information is verified using the information from the social network page, the social network information should be valid. Participants may attempt to set up a fake social network profile to certify his online dating profile; however, fake profiles can be identified. Social network profiles are typically associated with “friends” or followers that form a relationship with the participant, such as through a request, and have access to that participant's social network profile. The relationship can be unilateral or bilateral, which simultaneously grants the participant access to the requesting friend or follower's social network page. Hereinafter, the terms “friend” and “follower” are used interchangeably with the same intended meaning, unless otherwise indicated.

Valid social network profiles tend to be associated with a higher number of friends than fake profiles since a user of a fake profile likely does not wish to include the friends of his real profile and attempts to friend unknown people may not be successful. Therefore, the validity of the social network page and information on that page can be supported by predetermined fields of validation data, including a number of friends the participant has on his social network page. The validation information is optionally obtained (block 37) from the social network service and displayed (block 38) on the participant's online dating profile. Upon locating a profile page of another, the participant can make a determination as to whether he believes the information certification based on the validation information, such as the number of friends.

In a further embodiment, personal information of the participant, such as birth date, telephone number, or email address, can be used to confirm the validity of the social network page by matching the personal social network information with personal information of the participant provided to the online dating service. Notification that the personal data matches can be displayed, rather than displaying the data itself. For instance, if the validation data includes a birthday, notification that the participant's birthday on the social network service matches the birthday provided to the online dating service is displayed. Determining and displaying a validity measure of a social network page can be determined prior to, concurrently with, or after one or more information fields of the online dating profile are assigned a certified or uncertified status.

Information from a social network page can be used to certify one or more information fields of an online dating profile by comparing and matching the information or by uploading information from the social network page to the online dating profile. FIG. 3 is a flow diagram showing, by way of example, a method 40 for determining a certification status for an information field on an online dating profile. Information about the participant is obtained (block 41) from his social network page on a social network site. Next, a determination is made as to whether data for the information fields obtained from the social network page will be compared (block 42) with data for the corresponding information fields from the online dating profile.

Generally, the information to be compared can be determined based on a type of information, pre-selected fields of information, automatically determined information fields, or shared information fields. For example, the types of information to be compared can include all textual information, while photographs are not compared. In a further embodiment, photographs can also be compared using facial recognition technology to determine whether a photograph on the online dating site is valid and current. The information to be compared can be determined automatically or by an individual associated with the online dating site, the certification application, or the social network site.

After determining the information fields to be compared, data from those fields not being compared is received by and optionally displayed (block 44) on the online dating profile of the participant. In one embodiment, notification of the received data is provided on the online dating profile, rather than the data itself. Alternatively, for those information fields to be compared, data from each of the fields on the social network page are compared (block 43) with data from the same fields on the online dating profile. If the data matches (block 45), a verified status is assigned (block 47) to the corresponding information field on the online dating profile. Conversely, when the data does not match, a non-verified status is assigned (block 46).

The assigned status can displayed with the corresponding information field, as described above with reference to FIG. 2. The status can be displayed as an icon, such as a badge or certificate, pop up box, text, or photograph. Further, different images, color, font size, font type, or highlighting can be used to distinguish between certified and non-certified information fields. Other status displays are possible.

Participants may wish to certify one or more information fields on their online dating profile to encourage connections with other participants. FIG. 4 is a block diagram showing, by way of example, a screenshot of an introduction page 50 for certifying online dating profiles of participants. The introduction page 50 can include a Welcome message 51, a list of information fields 52 that can be certified and data that will be obtained from a social network page, and a disclosure notice 53. The Welcome message 51 can include a summary of the application to certify information on online dating profiles.

The list of information fields 52 can include one or more fields of information about the participant that is listed on the social network page, online dating profile, or both the social network page and online dating profile. The information fields can include age, relationship status, hair color, eye color, height, body type, zodiac sign, occupation, salary, children, smoker, drinker, exercise, religious beliefs, political views, charities, favorite movies, pets, hangout spots, hobbies, languages spoken, and education, as well as other types of information fields. The data can include text manually entered by the participant or a selection of a predetermined data option, such as through a drop down box, that is related to the corresponding information field. The list of information fields can include a full list of fields that can be certified or a partial list. If a partial list is displayed, the participant can obtain the remaining information fields on a different page of the certification application. Listing of the information fields can notify the participant of the data that will be obtained from their social network page, if certification is selected.

The disclosure notice 53 can include a statement identifying how accessed data from a social network page will be used. If the participant does not wish to continue with certification, a cancel button 55 can be selected. Alternatively, if the participant decides to continue with certifying one or more information fields of their online dating profile, a continue button 54 can be selected.

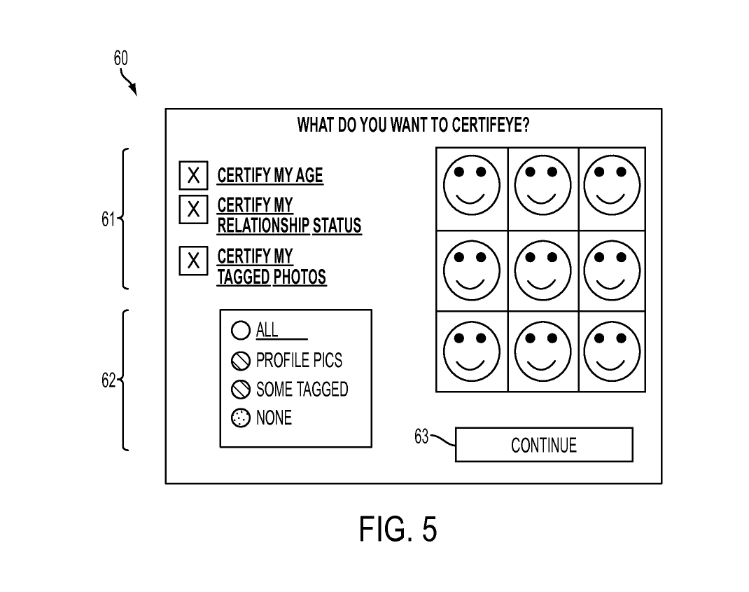

Selection of the continue button 54 can transfer the participant to a certification selection page. FIG. 5 is a block diagram showing, by way of example, a screenshot of a selection page 60 for selecting information fields to certify. The certification selection page 60 can include a list of information fields to certify 61 and sublists of information to certify 62. For instance, the information fields to certify can include those listed above with reference to FIG. 4. The sublists of information 62 can include one or more items of data listed by the participant for an information field. For instance, the sublist can include one or more items of data from information fields that allow participants to list multiple data items. For instance, the hobbies information field can include a listing of one or more hobbies, such as reading, running, sports, or music, as well as many others. The participant may wish to certify only a portion of his hobbies, rather than each hobby listed on his social network page. In one example, the participant lists five hobbies on his social network page, including reading, poetry, movies, running, and golf. However, the participant only lists the movie, running, and golf hobbies on his online dating profile. The participant can select to certify only those hobbies listed on his online dating profile. Alternatively, if the participant wishes to certify all the hobbies on his social network page, but his dating profile only listed a portion of those hobbies, the remaining hobbies on the social network page can be downloaded, displayed, and certified on the online dating profile.

In a further embodiment, the participant can select to have all of his photographs on his online dating profile certified or a portion of the photographs. Each photograph can be included in a sublist for the photograph information field. Alternatively, albums of photographs can be included in the sublist.

Once the participant selects the information fields and sublist data items to be certified, a continue button 63 can be selected. Upon selection of the button 63, data from the requested information fields is obtained from the participant's social network page. The social network page can be determined by default or selected by the participant via a text box, a drop down menu, a check box, or highlighting.

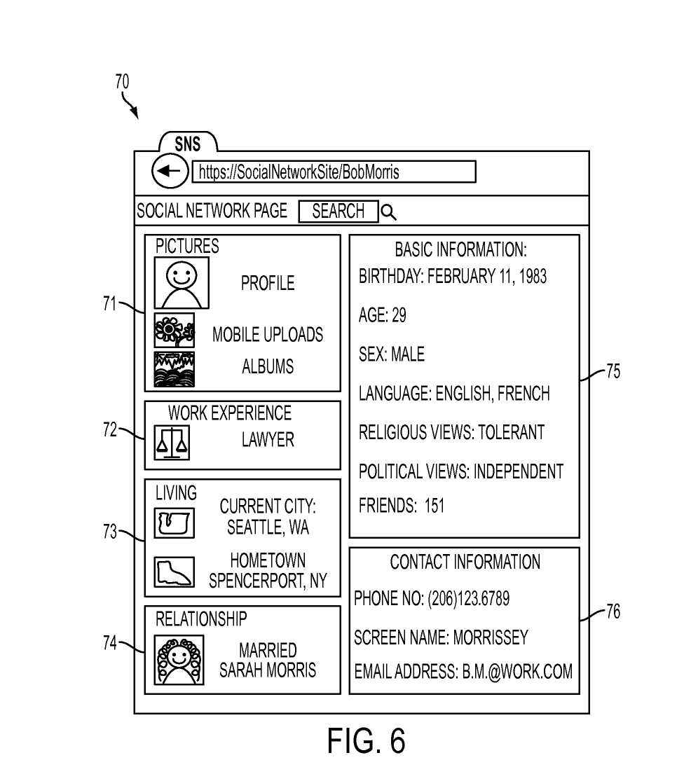

In one example, the participant selects the age, relationship status, and photograph fields for certifying on his online dating profile on the field selection page 60. Data for the age and relationship status fields, and photographs are accessed and obtained from the participant's social network page. FIG. 6 is a block diagram showing, by way of example, a screenshot of a social network page 70. The social network page 70 can include information regarding the participant, such as photographs 71, work experience 72, location 73, relationship status 74, personal information 75, and contact information 76. The photographs 71 can be divided into profile photographs, mobile uploads, and albums, as well as other groupings. The work experience 72 can list the participant's profession, as well as volunteer positions. The location section 73 can list one or more of a city of residence, a hometown, or previous cities in which the participant lived. The relationship section 74 can include a relationship status of the participant, as well any the participant's partner, if involved in a relationship. The personal information 75 can include birthday, age, language, religious views, political views, and a number of friends associated with the participant's social network page, while the contact information section 76 can include a telephone number, screen name, and email address. Other types of information provided on the social network page are possible.

Data associated with the selected information fields is obtained from the social network page for certifying the information provided on the online dating profile. Returning to the above example, only the age data and relationship status data are obtained from the social network page and compared with corresponding data on the participant's online dating profile, while photographs from the social network page are automatically downloaded to the online dating site. The photographs, once downloaded, are assigned a certified status. Meanwhile, the age data and relationship status data are compared to determine a status of the information. The age data on the social network page indicates that the participant is 29 and the relationship status data indicates that the participant is married. The age data on the participant's online dating site identifies the participant as 29 years old and having a relationship status of single. The age data and status data for the social network page and online dating profile are compared. A certified status is assigned to the age information field on the online dating site since the age data matches. An uncertified status is assigned to the relationship status field on the online dating site since the participant's social network page says married, while his online dating profile lists him as single.

In one embodiment, a certified status is assigned when the data is an exact match. For instance, if the participant's relationship status on the social network page is “its complicated” and the status on the dating profile is single, no match exists. In a further embodiment, a certified status is assigned when the data is closely related. For example, if the participant's age is listed as 28 on his social network page and as 29 on his online dating profile, a match may be identified since the ages are very close and may be off due to an inadvertent error in entering a birth year or month.

In a further embodiment, an undetermined status can be assigned to an information field or subfield, instead of the certified or uncertified status. The undetermined status can be assigned when the data for an information field does not match. For example, a social network page may have predetermined data choices for a relationship status field, such as married, single, divorces, widowed, and its complicated, whereas the online dating site may only include preselected choices for single, divorced, widowed, and never been married. An undermined status may be assigned when, for instance, a participant's social network profile lists the relationship status as “its complicated,” while the online dating profile lists the participant's status as single.

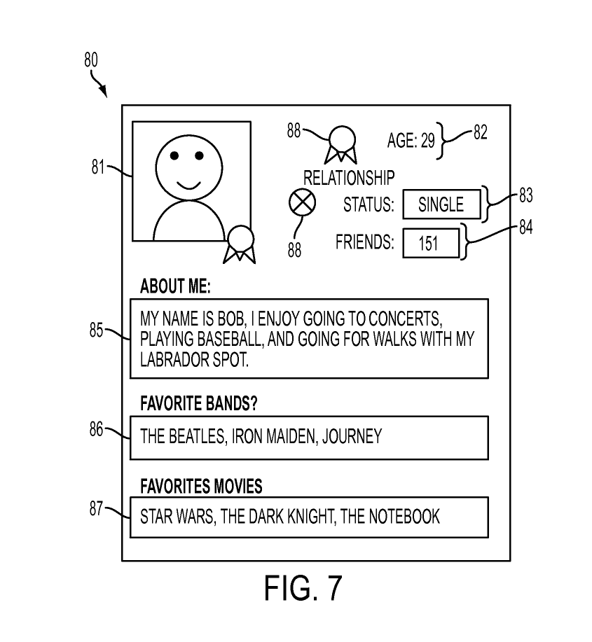

The status, once assigned, can then be displayed on the participant's online dating profile. FIG. 7 is a block diagram showing, by way of example, an online dating profile page 80 with field certification. The online dating profile page 80 can include information about a participant, including age 82, relationship status 83, biography 85, favorite bands 86, and favorite movies 87, which are listed in separate information fields. Other information fields are possible as described above with reference to FIG. 4. Additionally, photographs 81 of the participant can be posted on the dating profile, along with a number of friends 74 that the participant has on his social network page.

Returning to the above example, the age data 82 and photographs 81 were assigned a certified status, while the relationship status 83 was uncertified due to a mismatch of the data provided on the social network page and online dating profile. Notice that the age data is certified can be provided as a display on the online dating profile 80. For instance, the notices can include text, a pop up message, or an icon, such as a badge, circle, “x” symbol, or stop sign, as well as other types of icons. Further, notices of certified and uncertified data can be differentiated using color, font size, font type, or different notices, such as different icons or an icon and a pop up message. Other types of notices are possible. In this example, the certified status of the age field and photograph filed is displayed as a badge icon 88, while the uncertified status of the relationship status field is displayed as a circle with an “x” symbol. In a further example, one or more of the biography 85, favorite band 86, and favorite movie 87 fields can display a certified or uncertified status.

As described above, the information fields are certified or determined to be uncertified based on information provided on the participant's social network page. An indicator that the information from the social network page is true can be provided. The indicator can include a number of friends that the participant has on his social network page. A high number of friends, such as over 100 can indicate that the page is real, whereas a low number of friends can indicate that the page is fake. Other numbers of friends can be used. If a participant generates a fake social network page to certify his online dating profile, the participant is unlikely to have many friends since he will probably not want the friends of his real page to see the fake page. Further, an individual is unlikely to provide fake information, such as an unmarried status, on his social network page when the information is displayed to many of his friends, possibly including his wife.

The certified status indicators can encourage other participants viewing the user's online dating profile to contact the user since the information provided by the user is determined to be certified. Meanwhile, a participant may be hesitant or take additional precaution when contacting or interacting with a user that has not participated in information certification or that has uncertified information displayed on their profile page.

In a further embodiment, information that cannot be certified due to a mismatch of information provided on the online dating profile can be displayed automatically on the user's social network page to encourage users not to lie on their online dating profile.

While the invention has been particularly shown and described as referenced to the embodiments thereof, those skilled in the art will understand that the foregoing and other changes in form and detail may be made therein without departing from the spirit and scope of the invention.

What is claimed is:

1. A system for verifying online dating profiles, comprising:
a profile for a user on an online dating site;
a social network page for the user;
information about the user from the social network page, wherein the information comprises one or more fields of metadata;
a comparison module to compare the metadata from at least one of the fields on the social network page with metadata from a corresponding field of the online dating site and to determine whether the metadata of the social network page matches the metadata of the online dating site; and
a verification module to assign a certification status of the metadata for at least one of the fields on the online dating site by assigning a certified status to the metadata when a match occurs and assigning an uncertified status to the metadata when no match occurs.

2. A system according to claim 1, further comprising:
a display module to display the uncertified status for the unmatching metadata on the online dating site.

3. A system according to claim 1, further comprising:
a display module to display the uncertified status for the unmatching metadata on the social network page.

4. A system according to claim 1, further comprising:
a display module to display the certified status of the matching metadata on the user profile of the online dating site.

5. A system according to claim 4, wherein the display of the certified online dating site metadata is displayed via at least one of text, icons, or a pop up box.

6. A system according to claim 4, wherein the display module provide the display of the certified online dating site metadata as a badge adjacent to the corresponding field of metadata.

7. A system according to claim 1, further comprising:
a validation module to validate the metadata on the social network page by obtaining a number of friends on the user's social network page and by displaying the number of social network friends on the profile for the online dating site.

8. A system according to claim 1, wherein the fields of metadata comprise at least one of age, relationship status, location, height, weight, hair color, eye color, occupation, salary, kids, smoker, drinker, exercise, religious beliefs, political views, charities, movies, pets, hobbies, books, languages, education, number of friends, and photographs.

9. A system according to claim 1, further comprising:
a photograph verification module to obtain photographs from the user's social network page, to upload the photographs on the user's online dating profile, and to certify the photographs on the online dating profile.

10. A system according to claim 1, further comprising:
an assignment module to assign an unverified status to photographs displayed on the user's online dating profile when none of the photographs are uploaded from the user's social network page.

11. A method for verifying online dating profiles, comprising:
retrieving a profile for a user on an online dating site;
identifying a social network page for the user;
accessing information about the user from the social network page, wherein the information comprises one or more fields of metadata;
comparing the metadata from at least one of the fields on the social network page with metadata from a corresponding field of the online dating site;
determining whether the metadata of the social network page matches the metadata of the online dating site; and
assigning a certification status of the metadata for at least one of the fields on the online dating site, comprising one or more of:
assigning a certified status to the metadata when a match occurs; and
assigning an uncertified status to the metadata when no match occurs.

12. A method according to claim 11, further comprising:
displaying the uncertified status for the unmatching metadata on the online dating site.

13. A method according to claim 11, further comprising:
displaying the uncertified status for the unmatching metadata on the social network page.

14. A method according to claim 11, further comprising:
displaying the certified status of the matching metadata on the user profile of the online dating site.

15. A method according to claim 14, wherein the display of the certified online dating site metadata is displayed via at least one of text, icons, or a pop up box.

16. A method according to claim 14, further comprising:
providing the display of the certified online dating site metadata as a badge adjacent to the corresponding field of metadata.

17. A method according to claim 11, further comprising:
verifying the metadata on the social network page, comprising:
obtaining a number of friends on the user's social network page; and
displaying the number of social network friends on the profile for the online dating site.

18. A method according to claim 11, wherein the fields of metadata comprise at least one of age, relationship status, location, height, weight, hair color, eye color, occupation, salary, kids, smoker, drinker, exercise, religious beliefs, political views, charities, movies, pets, hobbies, books, languages, education, number of friends, and photographs.

19. A method according to claim 11, further comprising:
obtaining photographs from the user's social network page;
uploading the photographs on the user's online dating profile; and
certifying the photographs on the online dating profile.

20. A method according to claim 11, further comprising:
assigning an unverified status of photographs displayed on the user's online dating profile when none of the photographs are uploaded from the user's social network page.
